(19) United States
(12) Patent Application Publication
(10) Pub. No.: US 2025/0345802 A1
(43) Pub. Date: Nov. 13, 2025

(54) LINER FOR GYRATORY OR CONICAL CRUSHER

(71) Applicant: Metso USA Inc., Brookfield, WI (US)

(72) Inventors: Topi Markku Taneli Talvitie, Tursa (FI); Timothy David Brader, West Bend, WI (US); Mikko Kalevi Malkamaki, Vantaa (FI); Gregory Scott Schellinger, Milwaukee, WI (US)

(73) Assignee: Metso USA Inc., Brookfield, WI (US)

(21) Appl. No.: 18/658,188

(22) Filed: May 8, 2024

(51) Int. Cl. B02C 2/00

(52) U.S. Cl. CPC B02C 2/005

(57) ABSTRACT

A concave for gyratory or conical crushers including a front face for providing a crushing surface and a top face proximate to the front face or adjacent to the front face. A first internal angle measured around a top front edge of the concave, and between the front face and the top face, is greater than 90 degrees. A liner is formed including a first concave and a second concave. The first concave is axially above and adjacent the second concave such that a top face of the second concave is substantially parallel to a bottom face of the first concave. The substantially parallel faces define a joining surface at an angle Y with respect to vertical. A front face of the first concave and a front face of the second concave are substantially parallel and define a surface having an angle M with respect to vertical, wherein M+Y>90 degrees.

### TECHNICAL FIELD

The present disclosure relates to concave for a gyratory or conical crusher. It also relates to a liner made of a plurality of concaves. The present disclosure also relates to a gyratory or conical crusher having concaves.

### BACKGROUND

Gyratory or conical crushers are known for crushing or comminuting materials. A gyratory crusher typically comprises an upwardly-expanding frustoconical shell, i.e. the shell has a larger diameter at its upper end. The shell is provided with a liner that forms one crushing surface of the crusher. The liner may take many forms but are typically formed from multiple four-sided segments (i.e. four sides in addition to a front face and rear face) that have a curvature in at least one axis that allows the segment to generally match with the curvature of the frustoconical shape of the shell. Such liner pieces are commonly called “concaves”. In some cases, the concaves are fixedly mounted to the shell, e.g. using epoxy or other bonding material. In other cases, the concaves are mounted removably, e.g. with bolts extending through the shell and into a rear face of the concave.

The concaves are typically mounted in several rows or tiers within the shell. Each row may consist of multiple concaves which, together, cover a full 360° section of the frustoconical shell. Thus, a first row of concaves may cover a full 360° section of the shell. The next row is situated axially above the first row and may also be formed of multiple concaves which, together, cover a full 360° section of the frustoconical shell. Each row may comprise 5-20 concaves, such that each concave extends approximately 18°-72° degrees around the curve of the frustrocone. The number of rows varies depending on the size of the crusher and how easily handled a given size of concave may be. A typical crusher might have three to six rows of concaves. As the frustoconical shell has a larger diameter at its upper end and smaller diameter at its lower end, a radius of curvature of concaves in axially-higher-up rows may be larger than a radius of concaves in lower rows. There may be more concaves in axially-higher-up rows.

A downwardly-expanding frustoconical crusher head is disposed generally in the middle of the shell. The crusher head typically has an outer liner or “mantel” mounted thereon, where the mantel provides another crushing surface of the crusher. Towards or at its lower end, the crusher head passes through a hole in the base of the shell.

In a gyratory crusher, a beam or “spider” is mounted across the top of the shell and this spider supports the upper end of the frustoconical crusher head. That is, the frustoconical crusher head is narrower at its upper end, near the spider, and wider at its lower end. In a conical crusher, which are typically smaller overall than gyratory crushers, there is typically no spider or beam to support the top end of the crusher head. A conical crusher may use a shorter crusher head compared to a gyratory crusher. Other than these differences, the principles of operation of gyratory crushers and conical crushers (as described below) are essentially identical. In some setups, a gyratory crusher is used to crush the largest rocks down to some intermediate size, and one or more conical crushers are used downstream in the process to further crush the intermediate size rocks.

In gyratory or conical crushers, the crusher head is mounted eccentrically so that, as it is driven to rotate, its outer surface (i.e. the outer surface of the mantel) periodically moves closer-to and further-from any given point on the shell/liner. Material to be crushed is poured into the top of the shell, i.e. in the region between the liner and the mantel. Under the action of gravity, the material falls down within the shell to a position where it first contacts both the liner and the mantel, i.e. so the given piece of material is (briefly) supported between these two parts. If the crusher head/mantel is at a point in its eccentric path where it is moving towards said material, then the material will be crushed between the crusher head and the shell. Specifically, the crushing occurs between the liner on the shell and the mantel on the crusher head. If the crusher head is at a point in its eccentric path where it is moving away from said material, then this movement provides further room such that the material-to-be-crushed falls further down in the shell, under the action of gravity, until it again comes to rest between the liner and the mantel. After a crushing action on a given piece of material, the pieces may then either fall to a lower point within the crusher or, if crushed into pieces of sufficiently small size, the pieces may fall through an exit gap defined between the mantel and hole. An initially-large piece of material may be subjected to multiple crushing actions as it is broken into smaller pieces that head progressively lower within the shell towards the exit gap.

The mantle and liner thus provide two crushing surfaces and are subject to very high loads during operation of the crusher. The mantel liner and the concaves typically wear out comparatively quickly compared to other parts of the crusher and need to be replaced multiple times during the lifetime of the crusher. Replacing the liner requires that operation of the crusher is stopped and material is cleared out. This has a cost in terms of lost productivity. The new liners themselves also have a monetary cost and there is a labour cost for installing them. Therefore, it is desirable to have a liner that has a long service life, to minimize down-time and reduce the lifetime running costs and/or maintenance costs of the gyratory or conical crusher.

### SUMMARY

According to a first aspect, there is provided a concave for a gyratory or conical crusher, the concave comprising: a front face for providing a crushing surface, a top face proximate to the front face or adjacent to the front face, wherein a first internal angle (C) measured around a top front edge of the concave, and between the front face and the top face, is greater than 90 degrees.

The angle may be, by way of non-limiting examples, 95 degrees, 100 degrees, 105 degrees, 110 degrees, 115 degrees, or 120 degrees. This angle makes the front face of the concave more resistant to wear in the region adjacent its top edge. Specifically, when installed in a shell of a crusher, the front face will be facing slightly upwards. During operation, the front face provides a crushing surface against which material, e.g. rocks, are crushed. In designs where the angle is equal to 90 degrees, the inventors found wear preferentially occurs at and adjacent the top front edge. Setting this angle>90 degrees means that a force vector (from a rock being crushed against the front face) that acts on the front face at a point near the top of the front face, is acting through a thicker region of the concave compared to a similar concave in which the angle is 90 degrees. Put in a simplified manner: a 90 degree angle here, as in the prior art, makes the concave more pointed at this region and the pointed part breaks off more easily during crushing operations. Making the angle greater than 90 degrees reduces how pointy this region is, and thereby reduces wear in this region of the concave.

This shape of the concave may be defined in an alternative but equivalent manner. That is: a first vector is defined as a vector normal to the front face in a region proximate to the top front edge, said first vector extending into the concave; a second vector is defined as a vector normal to the top face in a region proximate to the top front edge and extending into the concave; the first and second vectors are coplanar; and the angle (C′) between the first and second vectors is less than 90 degrees.

This alternative definition is equivalent to the definition given in the first aspect because the following relationship holds between the two: angle C+angle C′=180 degrees.

In some examples, the top face is adjacent to front face such that the front face meets the top face at the top front edge, wherein the first internal angle is measured around the top front edge and between
1) a point on the front face adjacent to the top front edge; and
2) a point on the top face adjacent to the top front edge.

That is, in some examples, the front face extends all the way to meet the top face, and these two faces are not separated by a chamfer. In these cases, the top front edge is a real, i.e. touchable, corner of the concave.

In some alternative examples, the top face is proximate to the front face, and the concave further comprising a chamfer between the top face and the front face, wherein the chamfer is a flat chamfer or a curved chamfer, and wherein the top front edge is an edge where the continuation of the front face intersects the continuation of the top face, and the first internal angle is measured around the top front edge and between
1) a point on the front face that is adjacent to the chamfer; and
2) a point on the top face that is adjacent to the chamfer.

That is, in some examples, the top face and front face are separated by a chamfer. In these examples, the top front edge, around which the aforementioned angle is measured, is not a touchable corner of the concave. Instead, the top front edge here is defined as the line where the continuation of the front face up, past the chamfer, and the continuation of the top face, past the chamfer, meet one another.

The concave may further comprise a bottom face, wherein a second internal angle (D) measured around a bottom front edge of the concave and between the front face and the bottom face is less than 90 degrees.

This second internal angle may also be defined in an alternate but equivalent manner. That is: a third vector is defined as a vector normal to the front face in a region proximate to the bottom front edge, said third vector extending into the concave; a fourth vector is defined as a vector normal to the bottom face in a region proximate to the bottom front edge and extending into the concave; the third and fourth vectors are coplanar; and the angle (D′) between the first and second vectors is greater than 90 degrees.

These two definitions of the angle of the bottom face relative to the front face are equivalent because the following relation between the two: angle D+angle D′=180 degrees.

Having the second internal angle less than 90 degrees may allow two concaves to be placed adjacent one another, such that the bottom face of one faces the top face of the other, with the two faces substantially parallel to one another. This may design may reduce gaps between two adjacent concaves which could otherwise provide weak points in a liner made from multiple concaves of the first aspect. Having the second internal angle less than 90 degrees may also allow the concave to fit well into a given shell, e.g. may allow the bottom face to sit flush against a supporting shelf of the shell when the concave is installed.

The concave may have a third internal angle (F) measured around a top rear edge of the concave, and between a point on a rear face of the concave adjacent to the top rear edge, and a point on the top face adjacent or proximate to the top rear edge, is less than 90 degrees, wherein the top rear edge is either an edge where the top face meets the rear face, or where a continuation of the top face meets a continuation of the rear face.

This third internal angle may also be defined in an alternate but equivalent manner. That is: a fifth vector is defined as a vector normal to the rear face in a region proximate to the top rear edge, said fifth vector extending into the concave; a sixth vector is defined as a vector normal to the top face in a region proximate to the top rear edge and extending into the concave; the fifth and sixth vectors are coplanar; and the angle (F′) between the first and second vectors is greater than 90 degrees.

These two definitions of the angle of the bottom face relative to the front face are equivalent because the following relation between the two: angle F+angle F′=180 degrees.

For concaves where the front face and rear face are parallel to one another, F+C=180 degrees. However, in some designs, the rear face may be non-parallel to the front face.

According to a second aspect, there is provided a liner for a gyratory crusher comprising a plurality of concaves, wherein each concave of the plurality of concaves is a concave according to any preceding aspect.

A liner having concaves according to the first aspect may have a longer service life, as (as discussed above) each concave has greater resistance to wear at or near its top front edge. The plurality of concaves may be arranged in a first row or tier that forms a full 360-degree annular shape. The liner may optionally comprise a second row or tier of concaves that forms a full 360-degree annular shape, wherein the second row is arranged above the first row.

According to a third aspect, there is provided a liner for a gyratory crusher comprising a first concave and a second concave; wherein the first concave is a concave according to the first aspect; wherein the second concave comprises: a front face for providing a crushing surface and a bottom face, wherein a second internal angle measured around a bottom front edge of the second concave and between the front face and the bottom face is less than 90 degrees.

The first concave and second concave may be arranged such that the top face of the first concave is facing towards and substantially parallel to the bottom face of the second concave, and the front face of the first concave is substantially parallel to the front face of the second concave.

Arranging the concaves in this manner may minimise gaps between the concaves and thereby reduce the formation of weak-points within the overall liner.

The first internal angle may be greater than 90 degrees by x-degrees, and the second internal angle may be less than 90 degrees by y-degrees, wherein x−y<10 degrees or wherein x−y<5 degrees or wherein x=y.

Having x=y or x≈y means that the two faces will be substantially parallel to one another. This may assist in the positioning of the concaves relative to one another when constructing the liner, e.g. by resting one concave on one below, where their parallel faces mean they sit flush on one another.

According to a fourth aspect, there is provided a liner for a gyratory or conical crusher having a shell, the liner comprising a first concave and a second concave, wherein the first concave is arranged axially above and adjacent to the second concave such that: a top face of the second concave is substantially parallel to a bottom face of the first concave, the substantially parallel faces defining a joining surface that is at an angle Y with respect to the vertical direction, and a front face of the first concave and a front face of the second concave are substantially parallel and define a surface having an angle M with respect to the vertical direction, wherein M+Y>90 degrees.

In prior art liners in which each concave has a 90 degree angle between their top face and front face, the joining surface between two concaves is perpendicular to the front faces. Thus, when installed in a shell having a conical angle X relative to the vertical direction, the joining surface points generally upwards at an angle of 90-X relative to the vertical direction. By contrast, in a liner according to the fourth aspect, the joining surface points more towards the horizontal direction than the prior art joining surface. In some embodiments, the joining plane of the liner of the fourth aspect will be oriented substantially horizontally. Having the joining plane horizontal or more-towards the horizontal reduces the likelihood of damage to the concaves at these joints caused by falling rocks/material. This also helps to strengthen the concaves in this region. This is because these concaves are thicker along the direction of a force vector, where the force vector is from a crushing action on a given rock, compared to prior art concaves having a 90 degree angle between the front face and the top face.

In this aspect, M is defined relative to the vertical direction, and Y is defined relative to the vertical direction. However, the sum of M+Y (i.e. M+Y>90 degrees) is independent of the angle the concaves are lying at with respect to gravity. Thus, for example, a given pair of concaves may be constructed where M+Y=110 degrees, and this sum of M+Y remains constant regardless of whether the concaves are then placed in a shell having a conical angle of 50 degrees or in a shell having a conical angle of 25 degrees etc. The only change that occurs for the liner between being installed in the shell having a 25 degree conical angle vs in the shell having a 50 degree conical angle, is that the joining plane will point more towards or less towards the horizontal, depending on the predetermined shapes of the concaves.

The second concave may be a concave according to any of claims 1-5. The first concave may be a concave according to any of claims 1-5. That is, having a plurality of concaves according to the first aspect may allow the construction of a liner according to the fourth aspect.

The liner may further comprise a third concave configured to be located axially above and adjacent to the first concave within the shell, such that a top surface of the first concave is substantially parallel to a bottom surface of the third concave, such that the substantially parallel surfaces define a second joining surface, wherein an angle Z between the joining surface and the vertical direction exists such that M+Z>90 degrees.

This may improve the wear resistance of the liner at the join between the third and first concaves, by ensuring the joining plane between these two concaves is more towards the horizontal than in prior art designs. The same advantages therefore apply as discussed above.

M is defined relative to the vertical direction, and Z is defined relative to the vertical direction. However, the sum of M+Z (i.e. M+Z>90 degrees) is independent of the angle they are lying at. Thus, for example, a given pair of concaves may be constructed where M+Z=100 degrees, and this sum of M+Z remains constant regardless of whether the concaves are then placed in a shell having a conical angle of 45 degrees or a shell having a conical angle of 20 degrees etc.

Angle Z may be within 10 degrees of angle Y, optionally within 5 degrees, and further optionally wherein angle Z is equal to angle Y.

The first concave may be separated from the second concave by a clearance gap, preferably wherein the clearance gap is between 1 mm and 15 mm. Alternatively, the first concave may be in contact with the second concave. Put another way, the first concave may be separated from the second concave by 0-15 mm.

The clearance gap may be filled with epoxy or zinc, for example. These materials may help to mount the concaves within a shell, and may help to prevent ingress of crushed material into gaps between the concaves.

According to a fifth aspect, there is provided a gyratory or conical crusher comprising: a shell; and the liner according to the second, third, or fourth aspects.

A gyratory or conical crusher having a liner according to one of these designs may have a longer usable life between servicing stops. Thus, the crusher may have increased overall throughput in a given timeframe, due to a reduction in the number of times the liner needs to be repaired or replaced.

The first concave may be separated from the second concave by a clearance gap, preferably wherein the clearance gap is between 1 mm and 20 mm, further preferably between 1 mm and 10 mm. In other examples, the first concave may be in contact with the second concave (i.e., with no gap between the first concave and the second concave). Put another way, the first concave may be separated from the second concave by 0-15 mm.

The first concave and second concave may be arranged such that the first concave overhangs the second concave, preferably wherein an overhang distance of the overhang is less than 20 mm.

The overhang may help to protect the top face of the second (lower) concave from rock impacts from above. This may additionally help to prevent wear from occurring near the top front edge of the second (lower) concave.

### BRIEF DESCRIPTION OF THE DRAWINGS

Aspects of the invention will now be described, by way of non-limiting example, with reference to the following drawings, in which:

FIG. 1 shows a cross-sectional view of crusher with a known design of liner;

FIG. 2A shows concaves within a crusher showing wear on the concaves;

FIG. 2B shows the cross-sectional view of FIG. 1 with force vectors depicted;

FIG. 2C shows an enlarged section from FIG. 2B;

FIG. 3A shows a perspective view of a known design of a concave;

FIG. 3B shows a plan view of the concave of FIG. 3A;

FIG. 3C shows a cross-sectional view of the concave of FIG. 3A;

FIG. 4A shows a perspective view of a concave in accordance with the present disclosure;

FIG. 4B shows a plan view of the concave of FIG. 4A;

FIG. 4C shows a cross-sectional view of the concave of FIG. 4A;

FIG. 5A shows a cross-sectional view of a first alternate design of a concave in accordance with the present disclosure;

FIG. 5B shows a cross-sectional view of a second alternate design of a concave in accordance with the present disclosure;

FIG. 5C shows a cross-sectional view of a third alternate design of a concave in accordance with the present disclosure;

FIG. 6A shows a cross-sectional view of a crusher having concaves in accordance with the present disclosure;

FIG. 6B is an enlarged section of FIG. 6A;

FIG. 6C is another enlarged section of FIG. 6A; and

FIG. 6D shows the crusher of FIG. 6A with an overhang between two concaves.

### DETAILED DESCRIPTION

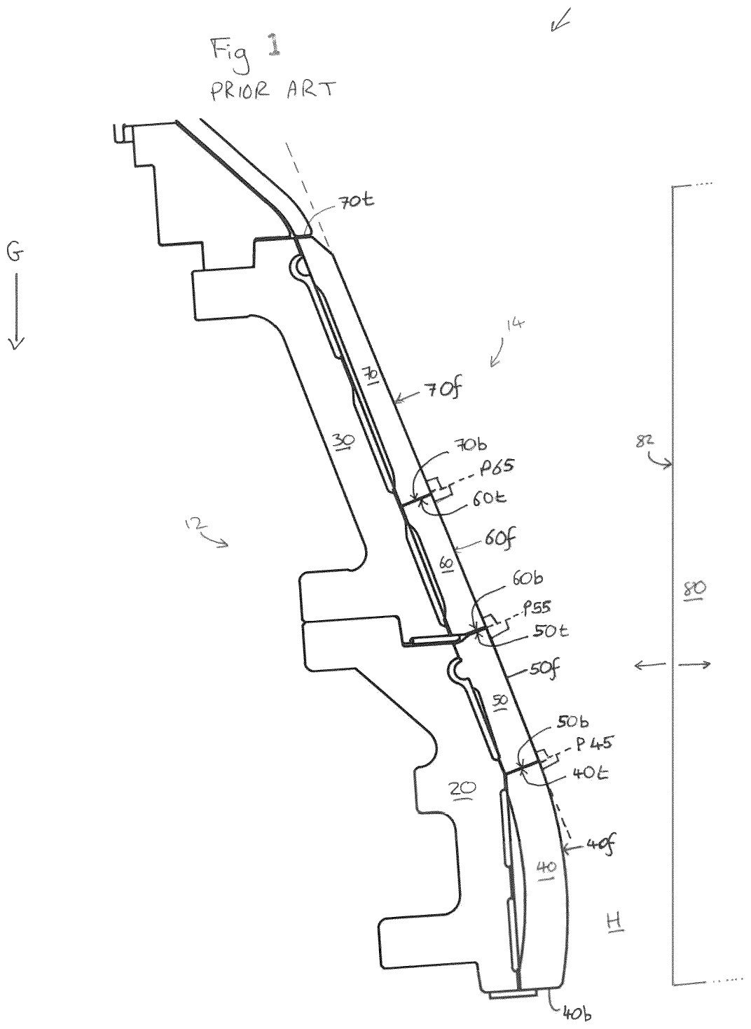

FIG. 1 shows a cross-sectional view of crusher 10 having a liner 14 of a known design. The direction of gravity is depicted with an arrow G. The depicted crusher 10 has no spider and so this example is a “conical crusher”. However, the following description applies equally to a gyratory crusher. Thus, the following description will refer to this simply as “crusher 10”, on the understanding that this description may be applied equally to conical crushers or gyratory crushers.

The crusher comprises a shell 12 and a frustoconical crushing head 80. The shell 12 in this example comprises a lower top shell 20 and an upper top shell 30. The upper top shell 30 and the lower top shell 20 are lined with the liner 14 that comprises a plurality of concaves 40, 50, 60, 70 mounted in rows. The liner 14 (i.e. concaves 40-70) provides one crushing surface of the overall crusher 10. Each of the concaves 40-70 has a respective front face 40f-70f that faces inwards, towards the crushing head 80. These front faces 40f-70f of the concaves 40-70 define the general frustoconical shape of the liner 14 and, consequently, define one crushing surface of the crusher 10. The shape defined by the concaves 40-70 may deviate from a perfect frustocone, as evident e.g. from the curved shape of the lowermost concave 40 in FIG. 1.

At least the inner surface of the shell 10 has a generally upwardly-expanding frustoconical shape, i.e. the diameter of the shell 10 is larger at its upper end and smaller towards its lower end.

The crusher head 80 is provided having a generally downwardly-expanding frustoconical shape. That is, the diameter of the crusher head 80 is smaller at its upper end and larger towards its lower end. The crusher head 80 mounted on an eccentric drive such that, as the crusher head 80 is rotated by the drive, its outer surface (mantel 82) moves periodically towards and away from any given point on the liner 14, as shown by the arrows in FIG. 1. The shell 12 and liner 14 together define a hole at the lower end of the shell 12 and the crusher head 80 extends up through the hole. There is an annular space H defined between the lower end of the shell 12 and the crusher head 80. The precise shape of annular space H changes from moment-to-moment as the crusher head 80 moves in its eccentric pattern, but the overall shape of the hole remains annular.

In use, material to be crushed is poured into the shell 12 from the top side, where “top” is defined with respect to gravity. Under the influence of gravity, the material falls down within the shell 12, bashing against the liner 14 and against the mantel 82 as it falls. An initially-large piece of material (e.g. a large rock) will fall to a level where it is (briefly) supported, at one end, via contact with one or more of the concaves 40-70 of the liner 14 and, at the other end, by contact against the mantel 82. Depending on what point of its rotation the crusher head 80 is at, at the moment when the aforesaid large rock first becomes supported between the mantel 82 and concaves 40-70, the mantel 82 will either be heading towards the concaves 40-70 at the point where they contact the rock or will be moving away therefrom.

If the mantel 82 is heading towards the location where the rock contacts the concaves 40-70, the rock will be crushed between the mantel 82 and the concaves 40-70. If the mantel 82 is heading away from the location where the rock contacts the concaves, then the space beneath the rock is opening up and the rock will slip further down within the shell 12 until it comes to rest again between the concaves and the mantel 82, to then be crushed when the mantel 82 returns towards the concave(s) that are currently supporting the rock. After this rock is crushed, some or all pieces of the crushed rock may be small enough to fall through the annular space H under the action of gravity. Any pieces that are too large to fall through the annular space H may be subjected to a further crushing process at a lower axial level within the crusher 10. Material exits the crusher 10 by falling through the annular space H, whereupon it falls into a bin or hopper, or is conveyed away on a conveyer belt, for example.

The concaves 40-70 are arranged in several rows or tiers. The lowest concave 40 shown in FIG. 1 is a first row concave 40. Immediately above the first row concave 40 is a second row concave 50. Immediately above the second row concave 50 is a third row concave 60. Immediately above the third row concave 60 is a fourth row concave 70.

In the following, for each concave, the letter “t” in a reference numeral refers to a top face, “b” refers to a bottom face, “l” refers to a left face, “r” refers to a right face”, “f” refers to a front face, and “re” refers to a rear face. The front face “f” of a given concave is the face that comes into contact with material to be crushed during operation of the crusher 10. When installed in a shell 12, the bottom face “b” of a given concave is below the top face “t” with respect to gravity. “Left” and “right” are defined when looking towards the front face “f” of a given concave.

A bottom face 70b of the fourth row concave 70 is generally adjacent to a top face 60t of the third row concave 60. A bottom face 60b of the third row concave 60 is adjacent to a top face 50t of the second row concave 50. A bottom face 50b of the second row concave 50 is adjacent a top face 40t of the first row concave 40. There may be a small clearance between each row of concaves. This clearance is typically 5-15 mm but may be smaller. That is, the bottom face 50b of the second row concave is 5-15 mm apart from the top face 40t of the first row concave etc. In some cases, this clearance is provided to accommodate manufacturing tolerances in the concaves of to accommodate growth of the material after installation. In some designs of crusher, this clearance is filled with a filler material such as epoxy or zinc. While four rows of concaves have been discussed herein with reference to FIG. 1, it should be understood that more or fewer rows of concaves may be used in different known designs of crusher.

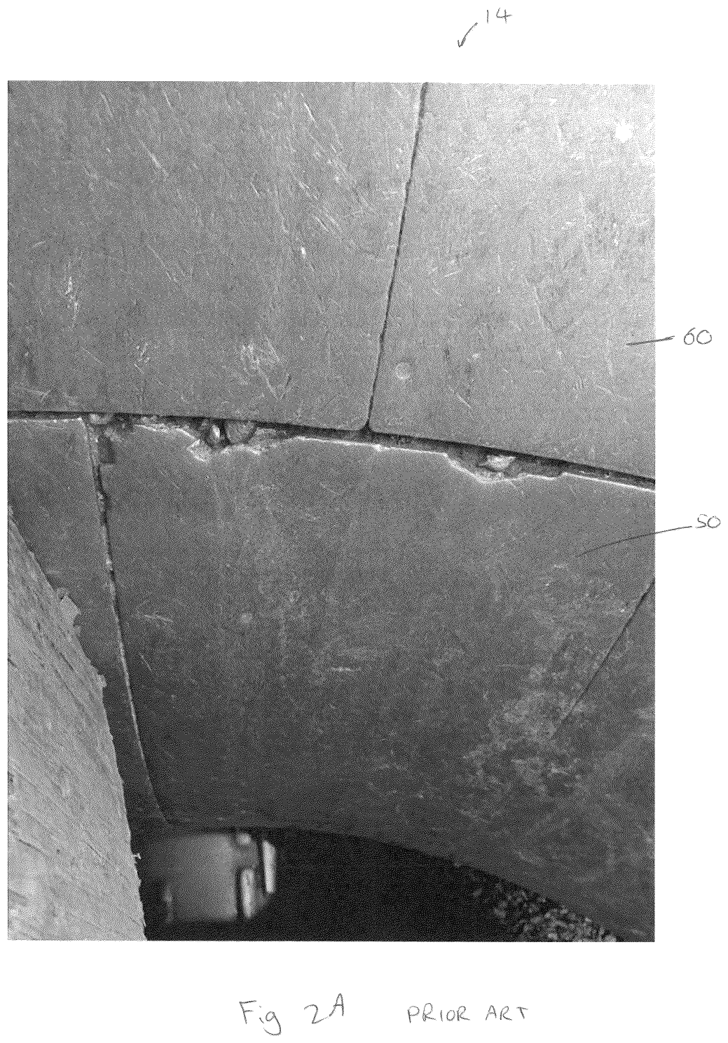

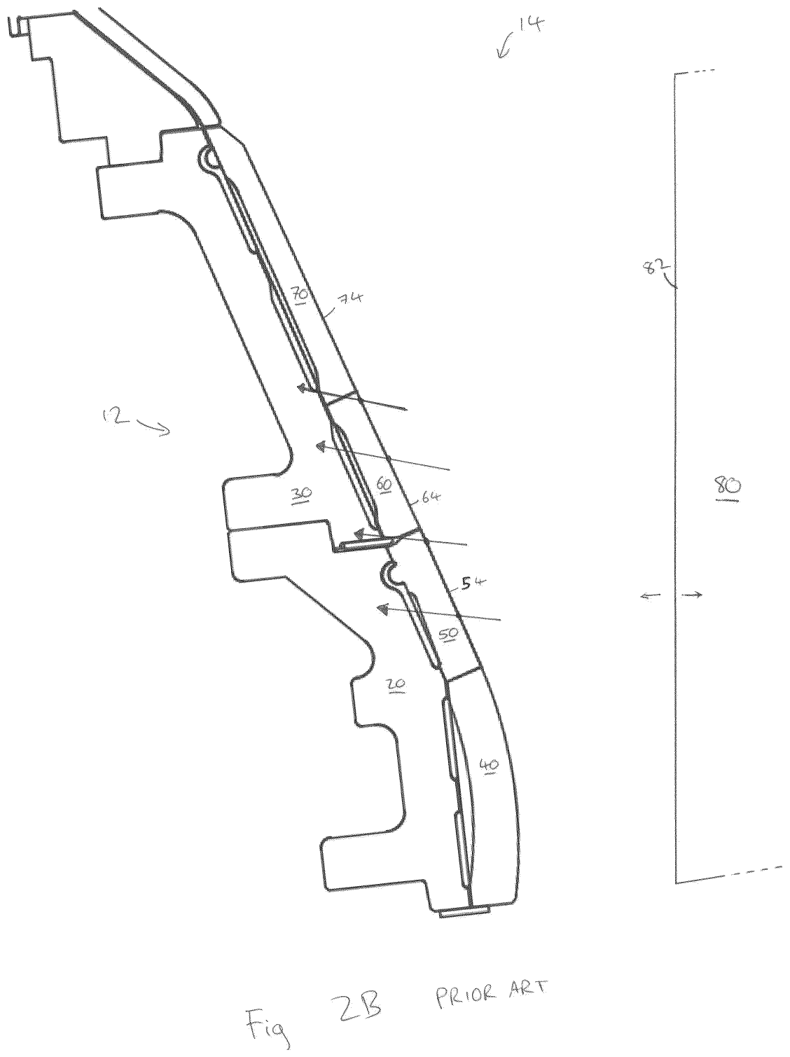

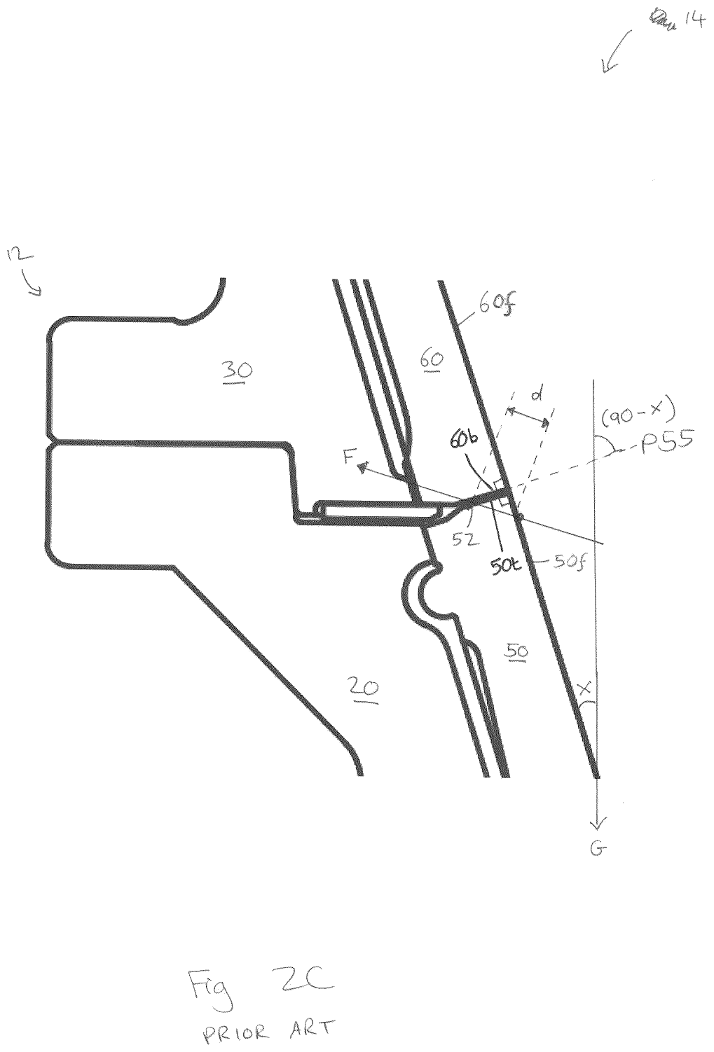

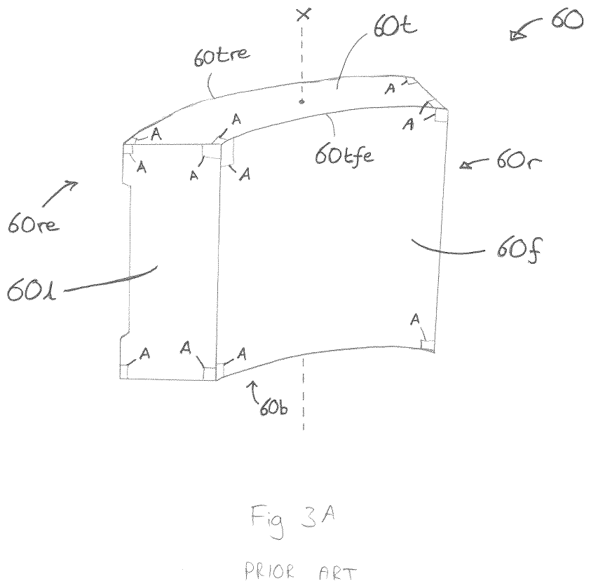

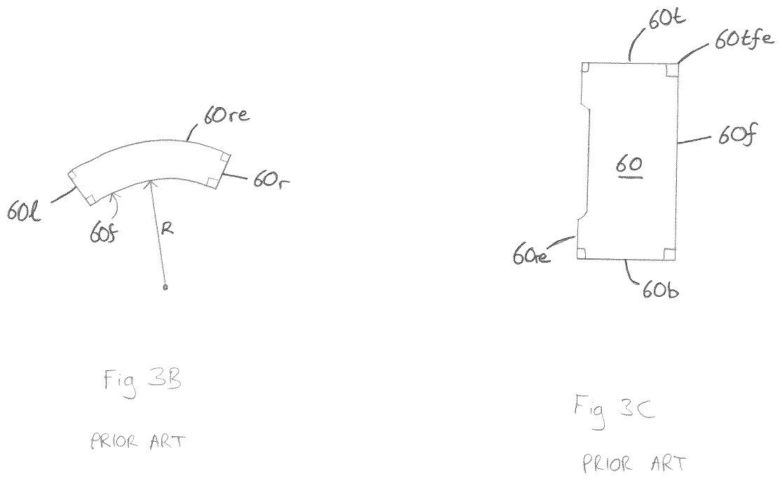

The present inventors have studied crushers designed in accordance with FIG. 1 discussed hereinabove, and have identified that wear on the concaves 40-70 occurs preferentially near the top edges of the concaves in each row, i.e. in the region of front face that is nearest to, or directly adjacent to, its top face. This is particularly true for concaves of the first to third rows. This preferential wear may be seen in FIG. 2A, where significant wear has occurred at the top of the front face of a first row concave. This significant level of wear had occurred within the first 10% of the expected service life of the concaves.

Due to the frustoconical shapes of both the inner surface of the liner 14 and the crusher head 80, when the crusher head 80 comes towards a given point on the concaves 40-70 to crush material (“a rock”), there is a large component of the crushing force in the horizontal direction, and a small component of the crushing force in the upwards direction. That is, the rock is “squeezed” slightly from its lower side, due to the frustoconical shapes, and is thus biased slightly upwards during a crushing action. This means that, during crushing, the force vector experienced by a given concave 40-60 is oriented radially outwardly and slightly above the horizontal direction. Typically, the force vector is angled about 0-40 degrees and typically 20-40 degrees above the horizontal plane. This force vector is depicted in FIG. 2B which shows the crusher 10 of FIG. 1 with several arrows. Each arrow depicts the main force vector experienced by the front face “f” of a given concave of the liner 14 when crushing material is being crushed at various axial heights during crushing operations.

FIG. 2C shows an enlarged view of the region where the second row concave 50 meets the bottom of the third row concave 60. The force vector F is shown near the top of the second row concave 50, and this shows the typical force experienced by the concave 50 when a rock rests against this location on the front face 50f of the concave 50 and is crushed by the crusher head 80. The concave 50 is generally rectangular in cross section and, in particular, there is a 90-degree angle between a front face 50f of the concave 50 and the top face 50t. Similarly, the concave 60 is also generally rectangular in cross-section and there is a 90-degree angle between the front face 60f and the bottom face 60b of the concave 60. These 90-degree angles mean that the bottom face 60b of the upper concave 60 and the top face 50t of the lower concave 50 are substantially facing one another and parallel to one another.

Each of the two concaves 50,60 depicted in FIG. 2C has a respective front surface 50f,60f. The front surfaces 50f,60f are substantially aligned with one another and substantially parallel to one another. Together these front faces 50f,60f define a conical angle X of the liner 14, where the angle X is defined with respect to the vertical, i.e. with respect to gravity G. As may be seen in FIG. 2B, typically the conical angle is essentially constant along the second 50, third 60, and fourth 70 concaves. That is, when viewed in cross-section in a plane defined by the vertical axis and a radial axis of the crusher 10, the second 50, third 60, and fourth 70 concaves may have flat front faces 50f,60f,70f. The conical angle X may change for the lowermost concave 40 towards its lower end. That is, when viewed in cross-section, the front surface 40f of the lowest concave 40 may curve.

The bottom face 60b of the upper concave 60 and top face 50t of the lower concave 50 are substantially parallel and define a joining surface P55 between the two concaves 50,60. The concaves 50,60 may be spaced apart by a short distance (e.g. 0-20 mm, preferably 5-20 mm; which space may optionally be filled by a filler material such as epoxy or zinc, for example), in which case the joining surface P55 is a plane parallel to both the top face 50t of the lower concave 50 and to the bottom face 60b of the upper concave 60 and located between the two concaves 50,60. The joining surface P55 is oriented perpendicular to the front surfaces 50f,60f of the two concaves 50,60 and perpendicular to the shell 12 behind the concaves 50,60. Consequently, the joining surface P55 is at an angle of 90-X (“ninety minus X”) degrees relative to the vertical direction G.

It is believed that wear preferentially occurs towards the upper edges of these concaves due to the aforementioned force vector. This is because, towards the top front edge of, for example, concave 50, where the front face 50f meets the top face 50t, the force vector is acting against a comparatively narrow portion of the concave 50, i.e. the corner of the concave 50, as may be seen in FIG. 2C. At this location, due to the clearance between concaves, the next-above concave (i.e. concave 60) does not provide extra material that is “behind” the corner that would, if present, provide support to the corner along this force vector. As such, the force vector F is acting through a comparatively thin and unsupported corner section of the concave 50, as indicated by the marked distance d. This area is therefore weaker and experiences wear more easily. Force vectors that are lower down and more towards the middle of a given concave (e.g. concave 50) act through the whole thickness of the concave 50 and thus, in these regions, the concave 50 is more resilient against wear.

In some cases, the clearance space between the concaves is filled with epoxy or zinc, for example. These materials are relatively soft and yielding compared to typical materials for concaves. As such, the filler material (epoxy, zinc etc.) does not provide any significant support to the thin corner of the concave in this location.

This problem of excessive wear at the upper edges of the concaves is particularly acute for concaves made of harder materials, such as high-chrome white iron and certain alloy steels. Such high-hardness materials are typically quite brittle. As such, the concave cannot flex or bend much before cracking. This means that the clearance between concaves ensures the upper concave does not provide any support to the highly-loaded upper corner of the lower concave before the lower concave has cracked. For more-deformable materials, the top front edge of a given concave may potentially deform until it contacts the concave above, the concave above thereby providing support to the deformed top front edge, and thereby preventing further damage.

FIGS. 3A and 3B show perspective views of the concave 60 for use as one part of the liner 14 of the crusher 10. The overall shape of the concave 60 is that of a cuboid wherein the cuboid is curved in one dimension. While the following discussion of the shape of the concave is given in relation to the third row concave 60, it applies equally to the concaves 50,70 of the second and fourth rows as well. The first row concave 40 differs from the other concaves 50-70 because it is curved in the plane that is depicted in FIG. 1. Other than this difference, however, the below description in relation to the concave 60 applies equally to the first row concave 40.

The concave 60 has a front face 60f that provides the primary wear surface of the concave 60. That is, the front face 60f comes into contact with material to be crushed during operation of the crusher 10. The concave 60 has a left side face 601, a right side face 60r, a bottom face 60b, and a top face 60t.

The angle A between the top face 60t and the rear face 60re, measured about the top front rear edge 60tfe, is 90 degrees. The angle A between the top face 60t and the front face 60f, measured about the top front edge 60tfe, is 90 degrees.

FIG. 3B shows a top-down view of the concave 60. The concave 60 has a radius of curvature R. More precisely, the front face 60f has a radius of curvature R. The radius of curvature is normal to the front face 60f. The radius of curvature R will typically be equal to a radius of the shell 12 at that axial height (i.e. the axial height of that part of the respective concave) minus the thickness of the concave. In this manner, each concave (e.g. concave 60) may fit snugly against the shell 12 at a predetermined axial position within the shell 12.

The rear surface 60re may be flat or may have cavities, e.g. as shown in FIGS. 1, 3A, and 3C. Such cavities may be for accommodating a filling material (epoxy, zinc etc.) or other parts intended for mounting the concave, and/or for accommodating other equipment such as sensors.

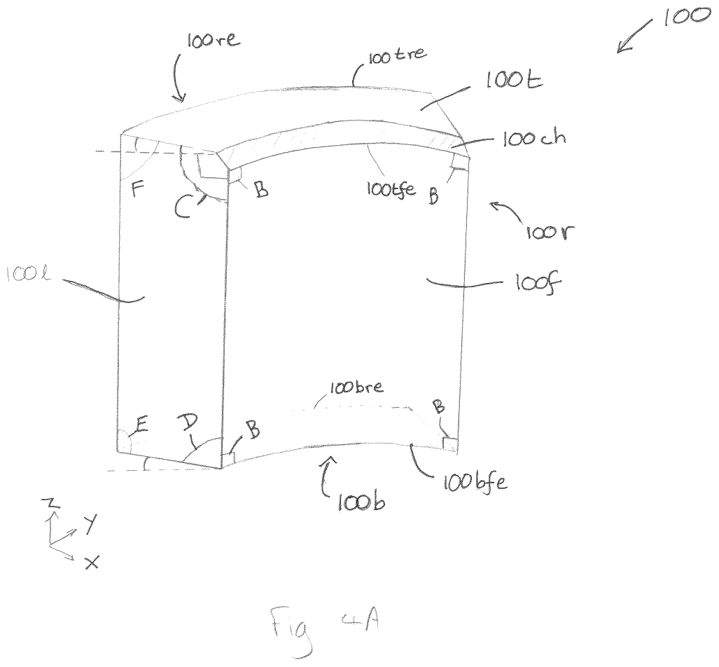

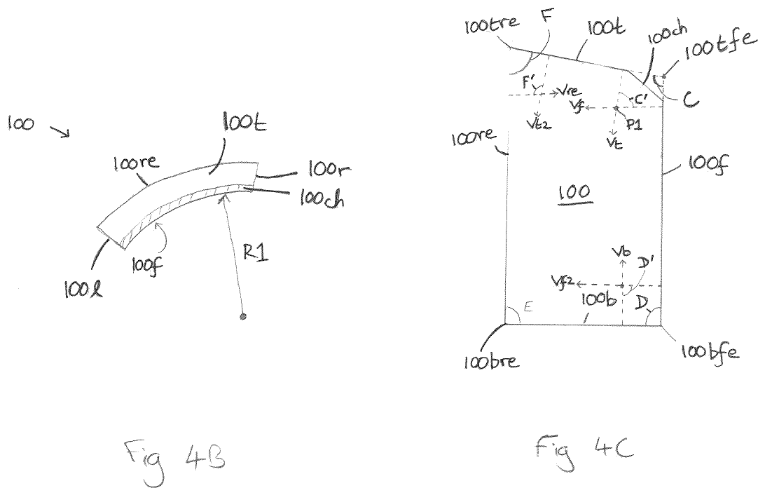

FIGS. 4A and 4B show a design of concave 100 according to the present disclosure. The concave 100 of FIGS. 4A and 4B has several similarities to the concave 60 of FIGS. 3A and 3B, along with some differences. The concave 100 is described in relation to a crusher 101 that may be a conical crusher or a gyratory crusher and will hereafter simply be referred to as a “crusher”. The concave 100 may, for example, be used in the crusher 10 described hereinabove. The original concaves 40-70 may, for example, be removed from the crusher 10 and may be replaced with a liner 114 that comprises at least the concave 100. That is, in one aspect, the present disclosure provides for retrofitting the shell of an existing crusher with a new liner 114.

The concave 100 has a front face 100f that provides the primary wear surface of the concave 100. That is, the front face 100f comes into contact with material to be crushed during operation of the crusher. The concave 100 has a left-side face 1001, a right-side face 100r, a bottom face 100b, and a top face 100t. The concave 100 depicted has a chamfered face 100ch between the front face 100f and the top face 100t. In these cases, a hypothetical top front edge 100tfe is defined as the line where the front face 100f would meet the top face 100t were the top face 100t continued straight along and the front face 100f continued straight up, i.e. as shown in FIG. 4C. That is, the continuation of the front face 100f upwards will meet the continuation of the top face 100t forwards at a line, and that line is the top front edge 100tfe. In other examples in which the chamfered face 100ch is not present, such that the front face 100f directly meets (joins to) the top face 100t, the top front edge 100tfe is simply the edge where the top face 100t meets the front face 100f. That is, in this case, the top front edge 100tfe is an uppermost edge of the front face 100f (as before) and is also a frontmost edge of the top face 100t.

In general, the chamfer, if present, begins at a location where the front face 100f first deviates from being (in cross section) a generally planar face. This deviation may be a sharp deviation where the front face meets the top face or meets a planar (flat) chamfered face, or may be where the gentle curve of a chamfer first measurably deviates from a plane of the front face.

In the example shown, the chamfered face 100ch is flat. A curved chamfered face is also possible. The left side face 1001 is “left” and the right-side face 100r is “right” when the concave 100 is viewed looking towards the front face 100f. The top face 100t is situated between the front face 100f and the rear face 100re and the bottom face 100b is situated between the front face 100f and the rear face 100re. When the concave 100 is installed in the crusher 101, the top face 100t is vertically higher than the bottom face 100b. The bottom rear edge 100bre is shown in dotted line in FIG. 4A.

XYZ axes are shown on FIG. 4A in which the top face 100t and bottom face 100b are separate from one another generally along the Z-axis. FIG. 4B shows a top-down view of the concave 100 (i.e. looking down along the Z-axis), and the curvature of the concave 100 in the XY plane may be clearly seen. The concave 100 has a radius of curvature R1. In this example, the radius of curvature R1 is constant at all axial heights between the top face 100t and bottom face 100b. In other examples, the radius of curvature may change along an axial height (i.e. between the top face 100t and bottom face 100b) of the concave 100. For example, the radius of curvature of the front face 100f may be smaller towards the bottom face 100b and larger towards the top face 100t.

A number of angles B-F are marked on FIG. 4A. Each angle labelled “B” is 90 degrees. Different from the concave 50 of FIGS. 3A,B, the angle C between the front face 100f and the top face 100t, measured around the top front edge 100tfe, is more than 90 degrees. More specifically, this means that the angle C is measured around the top front edge 100tfe, and between a point on the front face 100f closest to the top front edge 100tfe (i.e. adjacent to the top front edge or proximate to the top front edge) and a point on the upper face 100t that is closest to the top front edge 100tfe (i.e. adjacent to the top front edge or proximate to the top front edge), and angle C is greater than 90 degrees. Preferably, the angle C is in the range of 90°<C≤120°. Further preferably, the angle C is in the range of 95°<C≤120°.

The angle between the front face 100f and top face 100t may be defined in an alternative but equivalent way using normal vectors, as shown in FIG. 4C. A first vector Vf that is normal to the front face 100f, in a region near either the top front edge 100tfe (or near the chamfer 100ch, if present), and extending into the concave 100 may be defined. A second vector Vt that is normal to the top face 100t, in a region near the top front edge 100tfe (or near the chamfer 100ch, if present), may be defined. The first and second vectors are selected such that they are coplanar and, consequently, these vectors intersect one another at an intersection point P inside or behind the concave 100. The angle C′ between the two vectors Vt, Vf, around the intersection point P, is less than 90 degrees. By inspection, one may see that the relationship C+C′=180 degrees holds. This relationship provides the aforementioned equivalence between these two definitions of the angle between the top face 100t and front face 100f. That is, angle C is always greater than 90 degrees for concave 100, as above, and consequently angle C′ is always less than 90 degrees. As angle C increases, angle C′ decreases. Thus, when angle C is, for example, 110 degrees, angle C′ will be 70 degrees etc. This definition using normal vectors extending into the concave 100 may equally be used when defining the relative angles between other faces of the concave 100.

In cases where no chamfer 100ch is present, such that the front face 100f meets the top face 100t at the top front edge 100tfe, then the aforementioned point on the top face 100t will be adjacent (e.g. immediately adjacent) to the top front edge 100tfe. The angle C is measured internal to the concave 100. This is in contrast to an externally measured angle in which the path subtended by the angle is external to the body of the concave 100. In this context, “adjacent” the top front edge and “immediately adjacent” the top front edge, may be taken to mean that the point under consideration is within 10 mm of the top front edge, preferably within 5 mm of the top front edge.

In all cases, the angle C is measured in the plane that is perpendicular to the top front edge 100tfe. The top front edge 100tfe is curved in one dimension (i.e. it curves with the above-discussed curvature of the front face 100f around the circumference of the shell 12). As such, the angle C is defined as the angle between the aforesaid points on the front face 100f and top face 100t where these points lie in the plane that is perpendicular to the top front edge 100tfe at that location along the front face 100f of the concave 100.

Different from the concave 60 of FIGS. 3A-C, the angle D between the front face 100f and the bottom face 100b is less than 90 degrees. More specifically, a bottom front edge 100bfe is defined where the bottom face 100b and the front face 100f meet. The angle D is measured around the bottom front edge 100bfe, and between a point on the front face 100f adjacent (e.g. immediately adjacent) to the bottom front edge 100bfe and a point on the bottom face 100b that is adjacent (e.g. immediately adjacent) to a bottom front edge 100bfe, and angle D is less than 90 degrees.

The angle between the front face 100f and bottom face 100b may be defined in an alternative but equivalent way using normal vectors, as further shown in FIG. 4C. That is, a first vector Vf2 that is normal to the front face 100f, in a region near either the bottom front edge 100bfe, and extending into the concave 100 may be defined. A second vector Vb that is normal to the bottom face 100b, in a region near the bottom front edge 100bfe, may be defined. The first and second vectors are selected such that they are coplanar and, consequently, these vectors intersect one another at an intersection point inside or behind the concave 100. The angle D′ between the two vectors Vt, Vf, around the intersection point, is greater than 90 degrees. By inspection, one may see that the relationship D+D′=180 degrees holds. This relationship provides the aforementioned equivalence between these two definitions of the angle between the bottom face 100b and front face 100f.

In some examples, C+D=180° which means that, for a concave 100 where the front face 100f is flat (i.e. describes a straight line in the Z-dimension) the top face 100t and the bottom face 100b are parallel to each other. That is, the general shape of the cross section of the concave is a parallelogram. However, this is not essential, and angles C and D may be chosen independently of one another.

An angle F exists between the top face 100t and the rear face 100re. This angle is measured around an top rear edge 100tre between the top face 100t and the rear face 100re. Similarly, an angle E exists between the rear face 100re and the bottom face 100b, measured around a bottom rear edge 100bre between the rear face 100re and the bottom face 100b. Angles F and E are measured in essentially the same way as describe above for angles C and D, i.e. by measuring around the edge in a plane perpendicular to said edge, and taking points that are adjacent or closest-to the respective edge.

Typically, the rear face 100re of the concave 100 will be parallel to the front face 100f. As such, the angle F will be less than 90 degrees and the relation C+F=180 degrees holds.

The angle between the rear face 100re and top face 100t may be defined in an alternative but equivalent way using normal vectors, in the manner discussed above in relation to FIG. 4C. That is, again a first vector Vre that is normal to the rear face 100re, in a region near the top rear edge 100tre, and extending into the concave 100 may be defined. A second vector Vt2 that is normal to the top face 100t, in a region near the top rear edge 100tre, may be defined. The first and second vectors are selected such that they are coplanar and, consequently, these vectors intersect one another at an intersection point inside or in front of the concave 100. The angle F′ between the two vectors Vt, Vf, around the intersection point, is greater than 90 degrees. By inspection, one may see that the relationship F+F′=180 degrees holds. This relationship provides the aforementioned equivalence between these two definitions of the angle between the rear face 100re and top face 100t.

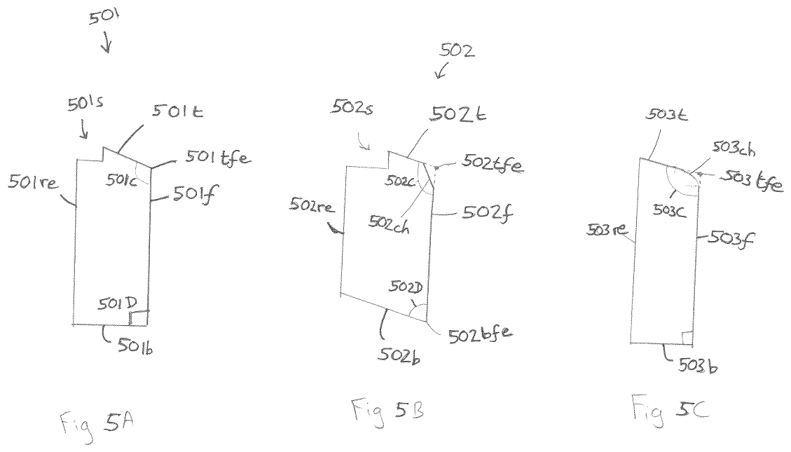

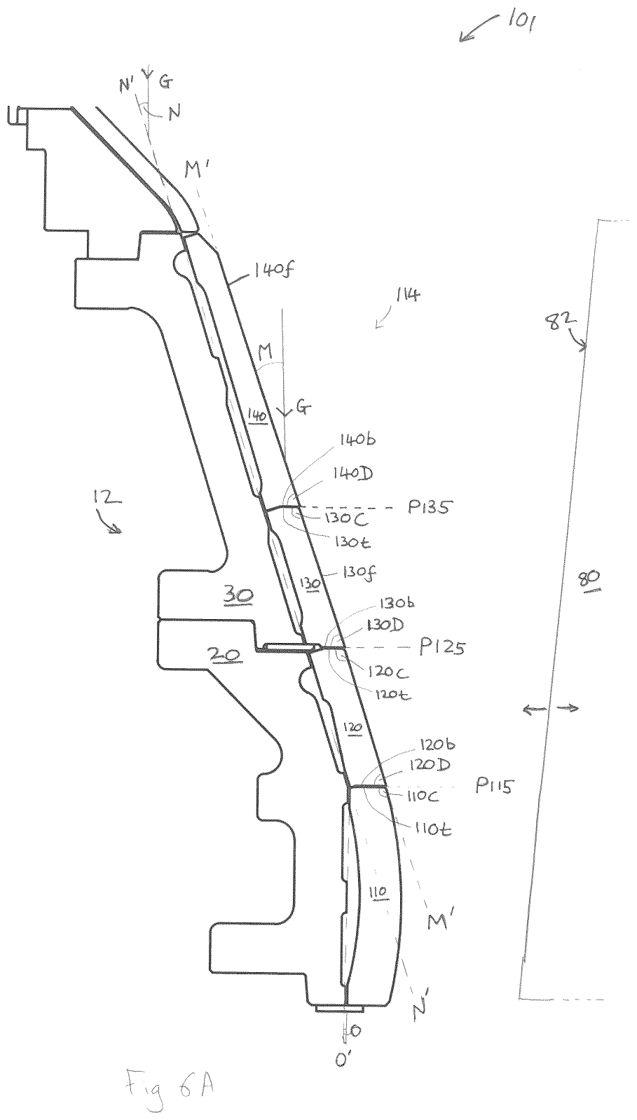

FIGS. 5A-C show cross sectional views of different designs of concaves 501-503, where concaves 501-503 are identical to the concave 100 described above except for the specific differences described below in relation to each concave 501-503. Features from any one of these concaves 501-503 may be matched with features from any other of these concaves.

In FIG. 5A, the top face 501t does not extend all the way from the front face 501f to the rear face 501re. Rather, there is a step change 501s between the top face 501t and the rear face 501re. The step change 501s may be provided, for example, to accommodate parts of the shell (e.g. shell 12). For example, in some crusher designs, such as the shell shown in FIG. 1, there is an upper top shell 30 that connects to a lower top shell 20. The step change 501s may accommodate a connection seam or connection bolt(s) between the upper and lower top shells 20,30, for example. In the example of FIG. 5A, there is no chamfer, so the top face 501t connects directly to the front face 501f at the top front edge 501tfe. In this example, the angle C is greater than 90 degrees. The angle 501D between the front face 501f and the bottom face 501b is 90 degrees.

In FIG. 5B, a chamfered face 502ch exists between the front face 502f and the top face 502t. Similar to FIG. 5A, there is a step change 502s between the top face 502t and the rear face 502re. In this example, C+D=180° such that the top face 502t and bottom face 502b are parallel. Angle 502C is measured between the front face 502f and the top face 502t, around the top front edge 502tfe, and C is greater than 90 degrees. Angle 502D is measured between the front face 502f and the bottom face 502b, and around the bottom front edge 502bfe and D is less than 90 degrees. In this example, angles C and D are selected such that the top face 502t and bottom face 502b are parallel to one another.

In FIG. 5C, a rounded chamfered face 503ch is provided between the front face 503f and the top face 503t. Dotted lines indicate the start and end of the chamfered surface 503ch. That is, these lines, for example, depict where the curve of the chamfered surface 503ch merges with the planar top face 503t (on one side) and merges with the planar front face 503f on the other side. The front face 503f is planar at least in the upper portion of the concave 503. Angle 503C is measured between the front face 503f and the top face 503t, around the top front edge 503tfe, and C is greater than 90 degrees. The top face 503t in this example extends all the way from the front face 503f to the rear face 503re. In this example C+D #180°, i.e., the top face 503t and bottom face 503b are not parallel.

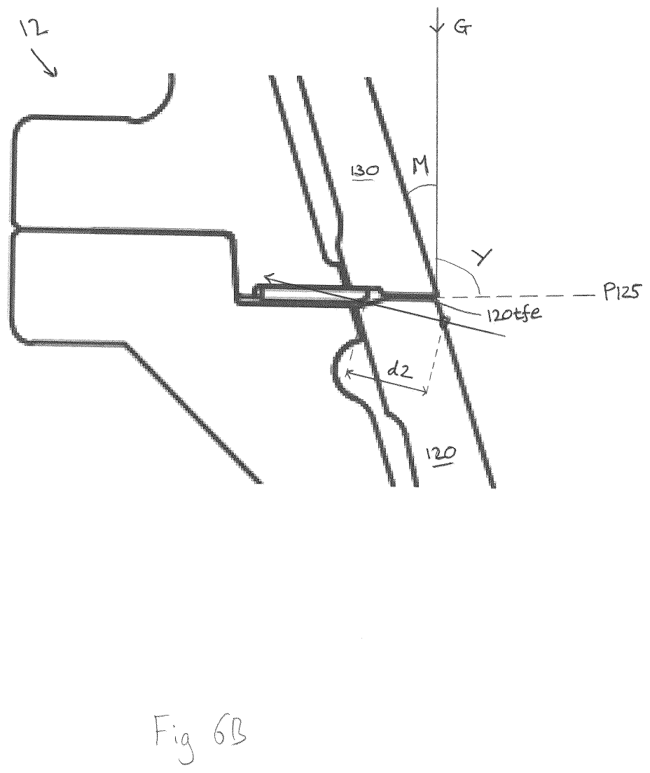

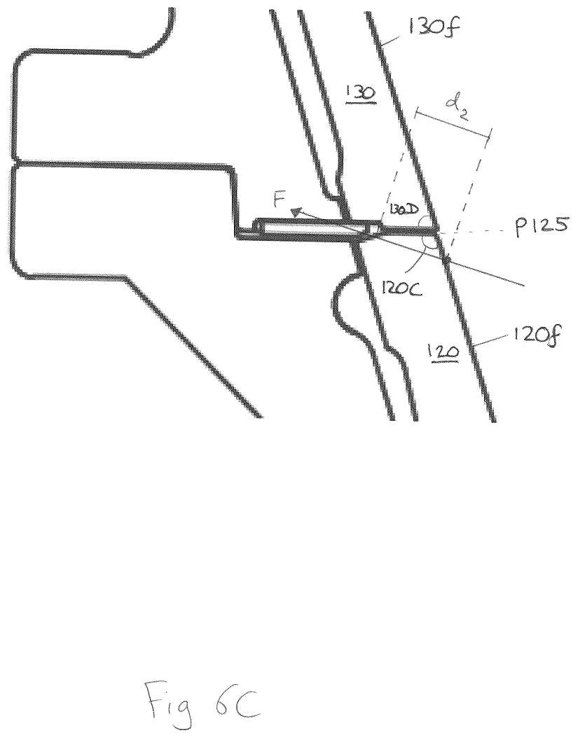

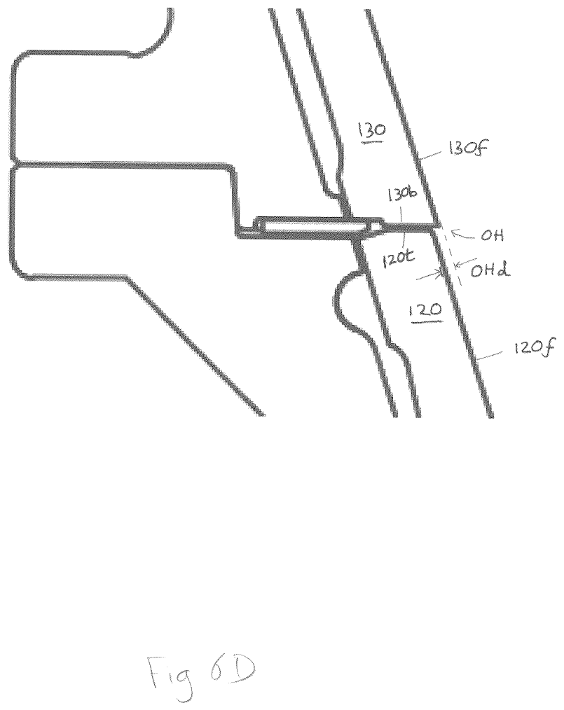

FIG. 6A shows a cross-sectional view of a crusher 101 having a liner 114. The crusher 101 may have the same shell 12 as discussed above in relation to FIG. 1. Put another way, the original liner 14 described above may be removed from the crusher 10 and replaced with a new liner 114 according to the present disclosure.

The new liner 114 comprises a plurality of concaves 110, 120, 130, 140. The lowest concave 110 is curved in the plane depicted in FIG. 6A. The concaves 120,130,140 of the second, third, and fourth rows each have a generally straight front face 120f, 130f, 140f in the plane depicted in FIG. 6A. These front faces 120f, 130f,140f are substantially aligned with one another and/or are parallel to one another (i.e. with a small amount of intentional misalignment, as discussed below). As such, the front faces 120f, 130f, 140f of the concaves of the second-to-fourth rows define a conical angle M with respect to the vertical direction, i.e., with respect to gravity G. The curve of the front face 110f of the lowest concave is set such that the uppermost portion of the front face 110f of the lowest concave 110 is aligned with and/or parallel to the front face 120f of the second row concave 120.

Each of the plurality of concaves 110,120,130,140 may be substantially similar to the concave 100 described hereinabove in relation to FIGS. 4A-5C. In particular, each of the plurality of concaves 110,120,130 (except for the top-most concave 140) has an angle 110C,120C,130C between its front face 110f,120f,130f and its top face 110t,120t, 130t, measured about its top front edge, that is greater than 90 degrees. Similarly, each of the plurality of concaves (except for the lowest concave 110) has an angle 120D,130D,140D, measured around its bottom front edge, between its bottom face 120b,130b, 140b and its front face 120f,130f,140f that is less than 90 degrees.

The angles 110C,120C,120D,130C,130D,140C are selected such that the top face of any given concave is substantially parallel to the bottom face of the concave immediately thereabove, and these substantially parallel faces define respective joining surfaces between the concaves. That is, there is a joining surface P115 defined between the first row concave 110 and the second row concave 120; a joining surface P125 defined between the second row concave 120 and the third row concave 130; and a joining surface P135 defined between the third row concave 130 and the fourth row concave 140. The various concaves 110-140 may each be spaced apart from one another by a short distance (e.g., 5-20 mm; which space may optionally be filled by a filler material such as epoxy or zinc, for example). In such cases, the joining surface between any two concaves is defined as a plane that is parallel to both the respective top face and bottom face that face one another, and is located between the two concaves.

Put another way, the angle 120C of the lower concave 120 may be greater than 90 degrees by F-degrees, and angle 130D of the upper concave may be less than 90 degrees by G-degrees. In some examples, F=G. However, F and G may differ slightly from one another, in particular due to manufacturing tolerances. Thus, for example, F-G (“F minus G”) is preferably less than 10 degrees and further preferably less than 5 degrees, and further preferably less than 2 degrees.

In the known crusher 10 and liner 14 of FIG. 1, there are surfaces P45,P55,P65 between the concaves 40,50,60. As described hereinabove, these surfaces P45,P55,P65 are perpendicular to the surface defined by the (flat) front faces 50f,60f,70f of the second to fourth rows of concaves and are perpendicular to the surface of the shell immediately behind the respective concaves. This perpendicular arrangement of the surfaces P45,P55,P65 results from the concaves 40-70 each having a 90 degree angle between its front face 40f-70f and its top face 40t-70t.

By contrast, each surface P115,P125,P135 is not perpendicular to the surface defined by the (flat) front faces 110f-140f of the concaves according to the present disclosure. Rather, each of the surfaces P115,P125,P135 are each oriented more towards the horizontal plane than each of the surfaces P45,P55,P65.

Put another way, the front faces 120f, 130f, 140f of each of the second to fourth row of concaves 120-140 define a surface M′, where the surface M′ defines a conical angle M with respect to the vertically upwards direction. Each of the joining surfaces P115,P125,P135 defines a respective plane angle, Y, with respect to the vertically upwards direction. Y may be the same for each plane or it may be different. In all cases, M+Y>90 degrees. In this manner, the respective joining surface P115,P125,P135 is not perpendicular to the plane defined by the front faces 120f, 130f, 140f, and is instead oriented more towards the horizontal.

FIG. 6B depicts a zoomed in view of where concave 120 meets concave 130 in FIG. 6A. The joining surface P125 is shown and, in the depicted example, the joining surface is approximately horizontal. As such, the angle Y between the vertical direction and the joining surface is 90 degrees. As before, angle M is the conical angle defined by the front faces 120f,130f of the two concaves 120,130, with respect to the vertically upward direction, and M+Y>90 degrees.

The shell 12 may define its own surface N′ upon which the concaves rest and this surface may form a conical angle N with the vertical direction G. Angle N may be identical to angle M. In other examples, M and N may be different. This may result, for example, by varying the thicknesses of the various concaves in the front-rear direction of each concave. The shell 12 may define a plurality of conical angles. For example, the shell 12 may define a first conical angle N (with respect to the vertical) in an upper portion of the shell 12 that is a relatively large angle, and may define a relatively small conical angle O (defined between a surface O′ and the vertical direction G) in a lower portion of the shell 12, close to the hole through which crushed material exits the crusher 101. Angle O may be close to or equal to zero degrees, for example.

FIG. 6C shows the same view as FIG. 6B with a force vector F added. This force vector F is the same vector as depicted in FIG. 2C in relation to the known design of liner 14. That is, the force vector is acting at the same linear distance from the top front edge of the respective concave in each of FIGS. 6C and 2C.

It may be seen from FIG. 6C that the force vector near the top of the concave 120 acts through a section of the concave 120 having a thickness d2. When concave 120 is made with the same dimensions as concave 60 (or, equally, as concave 50) except for the angle C about its top front edge, the thickness d2 in concave 120 will be larger than thickness d of concave 60 shown in FIG. 2. This is a direct result of the fact that the angle X between the top face 120t and the front face 120f of the concave 120 is greater than 90 degrees. This means that, for the same materials, the upper front corner of the concave 120 of FIG. 6C (i.e. proximate where the front face 120f and upper face 120f meet, optionally separated by a chamfer) is stronger than the upper corner of the concave 50 of FIG. 2C, because there is more material present (i.e. thickness d2 vs thickness d) to provide strength to the concave. This makes the concave 120 more resilient to damage in this region near the top front edge 120tfe. As discussed previously in relation to FIG. 2B in particular, this region of the known liner 14 and concaves 40-70, experienced significant wear compared to other areas. The concave 120 is therefore more resistant to wear as a result of the angle 120C (which is equivalent to angle C discussed in relation to the concave 100 design) being greater than 90 degrees.

Concave 130 is axially above concave 120. Concave 130 has an angle 130D between its front face 130f and its bottom face 130b, measured around a bottom front edge of the concave 130, which is equivalent to angle D discussed in relation to the concave 100 design. 130D and 120C are selected so that the bottom face 130b of the upper concave 130 is substantially parallel to the top face 120t of the lower concave 120. This may optionally help to avoid adding a new point of failure, e.g. this may prevent a given rock from lodging in a large gap between concaves 120 and 130, such that when it is loaded by movement of the crushing head 80, the rock loads against the bottom face 130b of the upper concave 130.

As shown in FIG. 6D, the upper concave 130 and lower concave 120 may be sized such that there is an overhang OH where the two concaves 120,130 come closest together. The overhang OH distance OHd may be defined as a linear shortest-distance between a front surface 120f of the lower concave 120 and a continuation of the front surface 130f of the upper concave 130. This overhang OH may optionally prevent or reduce material falling into the crusher 101 from impacting on the top face 120t of the lower concave 120 or impacting on the top corner (e.g. top front edge 120tfe) of the lower concave 120. This may thereby improve the overall wear resistance/lifetime of a liner 114 constructed using the concaves 120,130. An equivalent overhang may exist between each pair of concaves in the liner 114. In each case, the overhang may optionally provide this same advantage.

The lower part of the concave 110 of the lowest row is, in many designs, not subjected to particularly high crushing forces. That is, the bottom of the concave 110 may extend lower than the annular gap H. As such, the specific shape of bottom portion of this concave 110 may be any suitable shape. For example, as shown in FIG. 6A, the front face 110f of the lowest concave 110 may be curved outwardly (i.e. convex) such that the bottom portion of the front face 110f is further from an axial centre of the crusher 101 compared to a middle portion of this concave 110. This bottom face 110b may be configured such that, when the concave 110 is installed in the crusher 101, the bottom face 110b is in the horizontal (e.g. to rest against a ledge of the shell 12). As such, the angle between the front face 110f and the bottom face 110b, measured around the bottom front edge, and between a point on the front face adjacent (e.g. immediately adjacent) the bottom front edge and a point on the bottom face adjacent (e.g. immediately adjacent) or closest-to the bottom front edge, may be equal to or greater than 90-degrees.

The concaves 100,110,120,130,140,501-504 may be made from any suitable material. Suitable materials include alloy steels (such as ASTM A532A/532M steel, Class II Type B, or Class III Type A) or white iron. White iron offers very high wear resistance and comparatively low impact toughness. Alloy steels may offer low to medium wear resistance and medium to high impact toughness. The particular material choice may be made based on the intended use of the crusher, i.e. what material the crusher is primarily intended to crush.

1. A concave for a gyratory or conical crusher, the concave comprising:
a front face for providing a crushing surface, a top face proximate to the front face or adjacent to the front face,
wherein a first internal angle measured around a top front edge of the concave, and between the front face and the top face, is greater than 90 degrees.

2. The concave according to claim 1, wherein the top face is adjacent to front face such that the front face meets the top face at the top front edge, wherein the first internal angle is measured around the top front edge and between
1) a point on the front face adjacent to the top front edge; and
2) a point on the top face adjacent to the top front edge.

3. The concave according to claim 1, wherein the top face is proximate to the front face, and the concave further comprising a chamfer between the top face and the front face, wherein the chamfer is a flat chamfer or a curved chamfer, and wherein the top front edge is an edge where the continuation of the front face intersects the continuation of the top face, and the first internal angle is measured around the top front edge and between
1) a point on the front face that is adjacent to the chamfer; and
2) a point on the top face that is adjacent to the chamfer.

4. The concave according to claim 1, the concave further comprising a bottom face, wherein a second internal angle measured around a bottom front edge of the concave and between the front face and the bottom face is less than 90 degrees.

5. The concave according to claim 1, wherein a third internal angle measured around a top rear edge of the concave, and between a point on a rear face of the concave adjacent to the top rear edge, and a point on the top face adjacent or proximate to the top rear edge, is less than 90 degrees, wherein the top rear edge is either an edge where the top face meets the rear face, or where a continuation of the top face meets a continuation of the rear face.

6. A liner for a gyratory crusher comprising a plurality of concaves, wherein each concave of the plurality of concaves is a concave according to claim 1.

7. A liner for a gyratory crusher comprising a first concave and a second concave;
wherein the first concave is a concave according to claim 1,
wherein the second concave comprises:
a front face for providing a crushing surface and a bottom face,
wherein a second internal angle measured around a bottom front edge of the second concave and between the front face and the bottom face is less than 90 degrees.

8. The liner according to claim 7,
wherein the first concave and second concave are arranged such that the top face of the first concave is facing towards and substantially parallel to the bottom face of the second concave, and
the front face of the first concave is substantially parallel to the front face of the second concave.

9. The liner according to claim 7, wherein the first internal angle is greater than 90 degrees by x-degrees, and wherein the second internal angle is less than 90 degrees by y-degrees, wherein x−y<10 degrees or wherein x−y<5 degrees or wherein x=y.

10. A liner for a gyratory or conical crusher having a shell,
the liner comprising a first concave and a second concave,
wherein the first concave is arranged axially above and adjacent to the second concave such that:
a top face of the second concave is substantially parallel to a bottom face of the first concave, the substantially parallel faces defining a joining surface that is at an angle Y with respect to the vertical direction, and
a front face of the first concave and a front face of the second concave are substantially parallel and define a surface having an angle M with respect to the vertical direction,
wherein M+Y>90 degrees.

11. The liner according to claim 10, wherein the second concave includes a front face for providing a crushing surface, a top face proximate to the front face or adjacent to the front face,
wherein a first internal angle measured around a top front edge of the concave, and between the front face and the top face, is greater than 90 degrees.

12. The liner according to claim 10, further comprising a third concave configured to be located axially above and adjacent to the first concave within the shell, such that a top surface of the first concave is substantially parallel to a bottom surface of the third concave, such that the substantially parallel surfaces define a second joining surface, wherein an angle Z between the joining surface and the vertical direction exists such that M+Z>90 degrees.

13. The liner according to claim 12, wherein angle Z is within 10 degrees of angle Y, optionally within 5 degrees, and further optionally wherein angle Z is equal to angle Y.

14. The liner according to claim 10, wherein the first concave is separated from the second concave by a clearance gap, preferably wherein the clearance gap is between 1 mm and 15 mm, or wherein the first concave is in contact with the second concave.

15. A gyratory or conical crusher comprising:
a shell; and
the liner according to claim 6.

16. The gyratory or conical crusher according to claim 15, wherein the first concave is separated from the second concave by a clearance gap, preferably wherein the clearance gap is between 1 mm and 15 mm, or wherein the first concave is in contact with the second concave.

17. The gyratory or conical crusher according to claim 15, wherein the first concave and second concave are arranged such that the first concave overhangs the second concave, preferably wherein an overhang distance of the overhang is less than 20 mm.
